(19) United States
(12) Patent Application Publication
(10) Pub. No.: US 2009/0302672 A1
(43) Pub. Date: Dec. 10, 2009

(54) Automobile Axle

(76) Inventor: Mark Brooks, Hillsboro, MO (US)

Correspondence Address: HARSHAW RESEARCH, INC., 210 W. TECUMSEH STREET, OTTAWA, KS, 66067, US

(21) Appl. No.: 12/133,218

(22) Filed: Jun. 4, 2008

(51) Int. Cl. B60B 35/00

(52) U.S. Cl. 301/128

(57) ABSTRACT

A vehicle axle includes a main axle having an end defining a splined cavity. The vehicle axle further includes a splined shaft coaxial with the main axle, the splined shaft having a configuration that is complementary to a configuration of the splined cavity. The shaft and the main axle are coupled together by the shaft splines and the cavity splines, the shaft being movable relative to the main axle along the axis. The vehicle axle includes a force-absorbing member located inside the splined cavity and being in communication with the main axle and the splined shaft so as to absorb force when the splined shaft moves toward the main axle past an equilibrium point.

### BACKGROUND OF THE INVENTION

The present invention relates generally to automobile axles and, more particularly, to an automobile axle having a lateral shock absorber. Side impact forces and horizontal stresses related to cornering are decreased by the present invention.

When a force is applied to a car in a horizontal direction, such as a wind load, a side impact, or the centripetal force around a corner, the force will be felt first by the tires and they will bend slightly. This may lead to undesirable accelerated tire wear. If the force is great enough, the tires may begin to slip on the pavement, resulting in a loss of control.

Various devices have been proposed in the art for reducing side impact stresses upon a vehicle. Although assumably effective for their intended purposes, the existing devices do not adequately absorb horizontal stresses such that tire wear is reduced and the damage from side impact collisions is significantly reduced.

Therefore, it would be desirable to have a vehicle axle that absorbs horizontal stresses so as to make the vehicle ride better and be more responsive during evasive maneuvers, wear on vehicle tires is reduced, and the impact of a side collision is reduced. More particularly, it would be desirable to have a vehicle axle having a force absorbing member that biases the axle shaft outward and that absorbs horizontal forces encountered, say, when cornering or upon a side impact. Further, it would be desirable to have a vehicle axle having an axle shaft that slides within a main axle but resists axle recoil in the case of a side impact collision.

### SUMMARY OF THE INVENTION

Therefore, a vehicle axle according to the present invention includes a main axle having an end defining a splined cavity. The vehicle axle further includes a splined shaft coaxial with the main axle, the splined shaft having a configuration that is complementary to a configuration of the splined cavity. The shaft and the main axle are coupled together by the shaft splines and the cavity splines, the shaft being movable relative to the main axle along the axis. The vehicle axle includes a force-absorbing member located inside the splined cavity and being in communication with the main axle and the splined shaft so as to absorb force when the splined shaft moves toward the main axle past an equilibrium point.

The force-absorbing member includes at least one of a spring, a pneumatic damper, a hydraulic damper, and a permanently-deformable solid. The force-absorbing member is positioned to bias the splined shaft outwardly and to absorb horizontal forces imparted upon the splined shaft, such as those from the wind, vehicle cornering, or side impact. The vehicle axle may also include a safety pin that is biased to prevent further movement of the splined shaft relative to the main axle if the shaft is moved past a predetermined point. In other words, the safety pin prevents automatic return of the shaft to its unbiased configuration after an accident.

Therefore, a general object of this invention is to provide a vehicle axle that absorbs horizontal forces exerted upon a vehicle.

Another object of this invention is to have a vehicle axle, as aforesaid, that includes a splined shaft that is biased outwardly relative to a main axle for absorbing horizontal forces.

Still another object of this invention is to have a vehicle axle, as aforesaid, that prevents recoil of the splined shaft in case of a side collision.

Yet another object of this invention is to have a vehicle axle, as aforesaid, that reduces premature tire wear when a vehicle rounds a corner.

Other objects and advantages of the present invention will become apparent from the following description taken in connection with the accompanying drawings, wherein is set forth by way of illustration and example, embodiments of this invention.

### BRIEF DESCRIPTION OF THE DRAWINGS

FIG. 1 is a perspective view of an automobile axle according to an embodiment of the present invention;

FIG. 2a is an exploded view of the axle as in FIG. 1;

FIG. 2b is an isolated view on an enlarged scale of a portion of the vehicle axle taken from FIG. 2a;

FIG. 3a is a top view of the axle as in FIG. 1;

FIG. 3b is a sectional view taken along line 3b-3b of FIG. 3a;

FIG. 3c is an isolated view on an enlarged scale of a portion of the axle taken from a portion of FIG. 3b, with a force-absorbing member in an uncompressed configuration;

FIG. 3d is an isolated view on an enlarged scale of a portion of the axle taken from a portion of FIG. 3b, with a force-absorbing member in a compressed configuration;

FIG. 4a is a top view of a vehicle axle as in FIG. 1;

FIG. 4b is a sectional view taken along line 4b-4b of FIG. 4a;

FIG. 4c is an isolated view on an enlarged scale taken from a portion of FIG. 4a, showing a safety pin in a biased configuration;

FIG. 4d is an isolated view on an enlarged scale taken from a portion of FIG. 4a, showing a safety pin in an unbiased configuration;

FIG. 5a is sectional view as in FIG. 3a with a hydraulic damper in a compressed configuration;

FIG. 5b is a sectional view as in FIG. 5a showing the hydraulic damper in an uncompressed configuration;

FIG. 6a is a sectional view as in FIG. 3a showing a permanently deformable solid in an uncompressed configuration;

FIG. 6b is a sectional view as in FIG. 6a showing the permanently deformable solid in a compressed configuration;

FIG. 7a is a perspective view on an enlarged scale of the permanently deformable solid in an uncompressed configuration;

FIG. 7b is a perspective view on an enlarged scale of the permanently deformable solid in an compressed configuration; and

FIG. 8 is a block diagram of an adjustable force absorbing member.

### DESCRIPTION OF THE PREFERRED EMBODIMENT

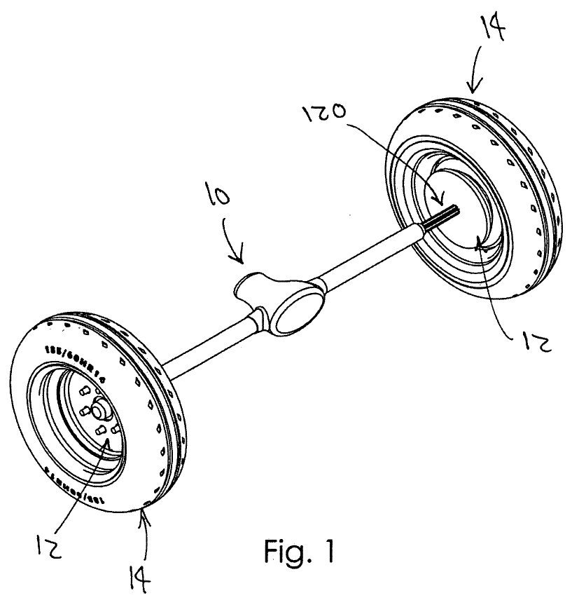

A vehicle axle will now be described in detail with reference to FIG. 1 through FIG. 8 of the accompanying drawings. More particularly, the vehicle axle 100 includes a main axle 110 and a shaft 120.

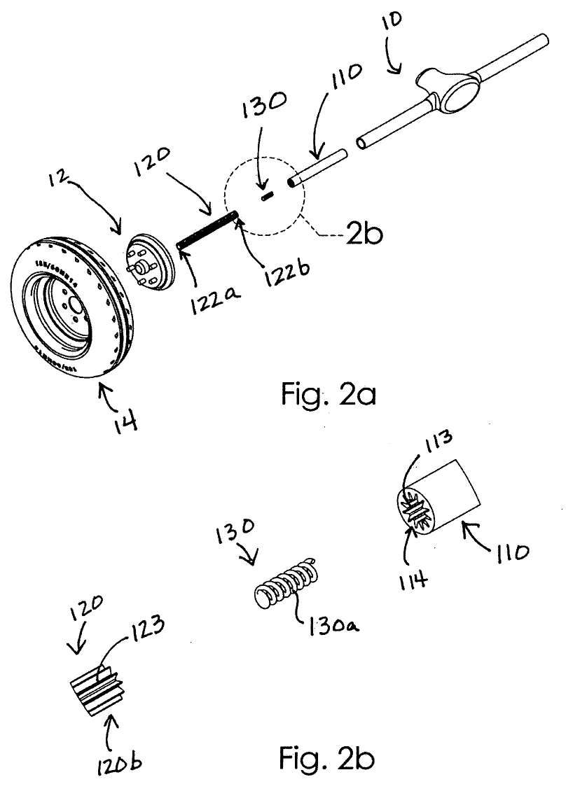

As shown in FIGS. 2a and 2b, the main axle 110 may be coupled to a vehicle's differential 10 or otherwise coupled to an automobile. The shaft 120 is elongate, has opposed ends 122a, 122b, and is coaxial with the main axle 110. Shaft end 122a is configured to be coupled to a vehicle hub 12, which is in turn coupled to a tire 14 as shown in FIG. 1. The shaft 120 is coupled to the main axle 110 and is movable relative to the main axle 110 along the shared axis. In other words, the shaft 120 can move along the shared axis so that the shaft end 122a moves toward and away from the main axle 110.

The shaft 120 may include a plurality of splines 123, and the main axle 110 may include a plurality of splines 113 that are complementary to the shaft splines 123. Interaction between the shaft splines 123 and the main axle splines 113 may couple the shaft 120 to the main axle 110 and cause the shaft 120 to rotate with the main axle 110 while allowing the shaft 120 to move along the shared axis. In one embodiment, as shown in FIG. 2b, shaft end 122b includes the splines 123 and the main axle 110 has an end 112 defining a cavity 114 with the splines 113.

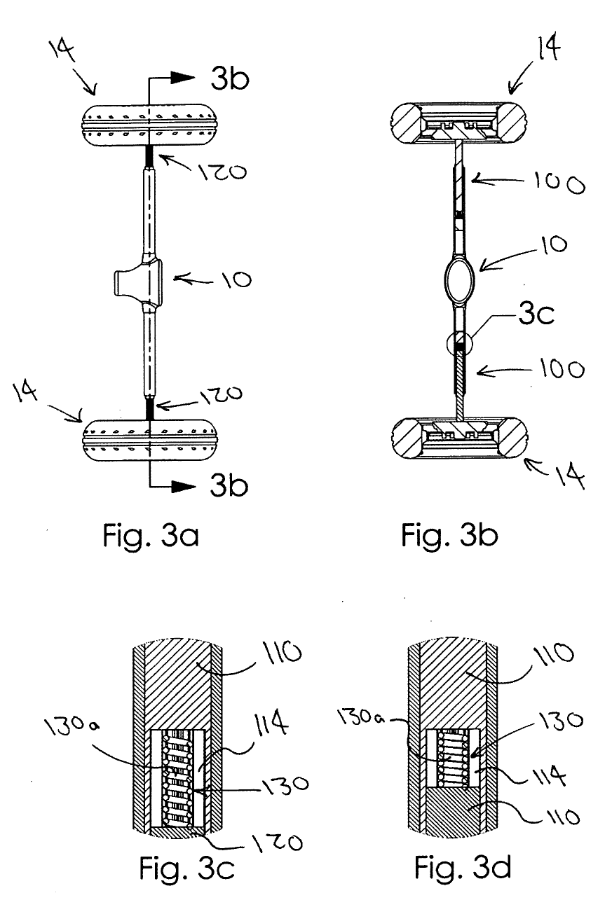

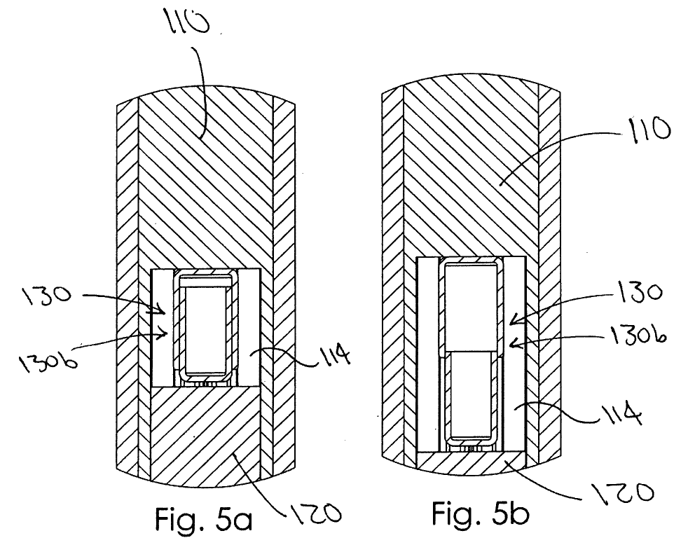

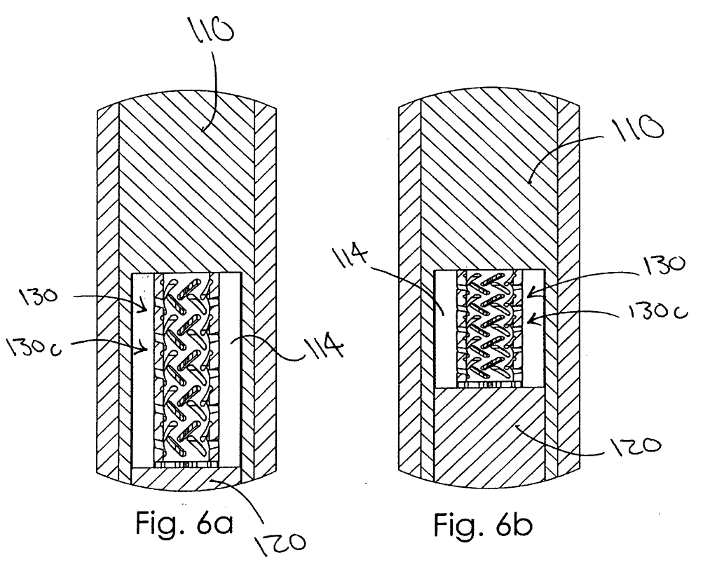

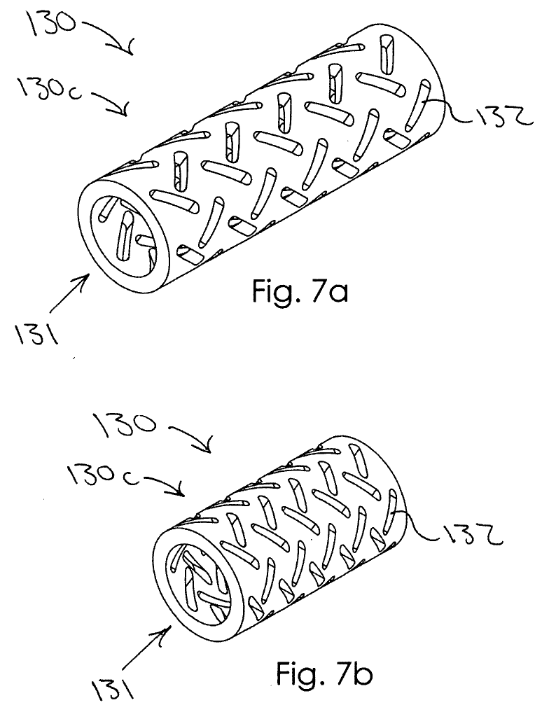

A force-absorbing member 130 is in communication with the main axle 110 and the shaft 120 to absorb force when the shaft 120 moves toward the main axle 110 (i.e., when the shaft end 122a moves toward the main axle 110) past an equilibrium point. As shown in FIGS. 2b, 3c, 3d, and 5a through 6b, the force-absorbing member 130 may be located inside the splined cavity 114. The force-absorbing member 130 may include, for example, a spring 130a (FIGS. 3c and 3d), a pneumatic or hydraulic damper 130b (FIGS. 5a and 5b), and/or a permanently-deformable solid 130c (FIGS. 6a through 7b). As shown in FIGS. 7a and 7b, the permanently-deformable solid 130c may be a hollow cylinder 131 having a plurality of holes 132 that allow compression, or any other permanently-deformable solid that absorbs energy through compression may be used.

If the shaft end 122b is coupled to the force-absorbing member 130, the force-absorbing member 130 is coupled to the main axle 110, and a resilient force-absorbing member 130 is used (e.g., spring 130a, etc.), the force-absorbing member 130 may additionally bias the shaft 120 toward the equilibrium point when the shaft 120 has moved away from the main axle 110 past the equilibrium point (i.e., when the shaft end 122a has moved away from the main axle 110 past the equilibrium point).

The equilibrium point is the point where the force-absorbing member 130 does not pull the shaft 120 toward the main axle 110 or push the shaft 120 away from the main axle 110, but where further movement of the shaft 120 toward the main axle 110 causes a change in the force-absorbing member 130. For example, if the force absorbing member 130 is a spring 130a, the equilibrium point is the point where the spring 130a neither pushes nor pulls the shaft 120 relative to the main axle 110, but where movement of the shaft 120 toward the main axle 110 causes the spring 130a to compress.

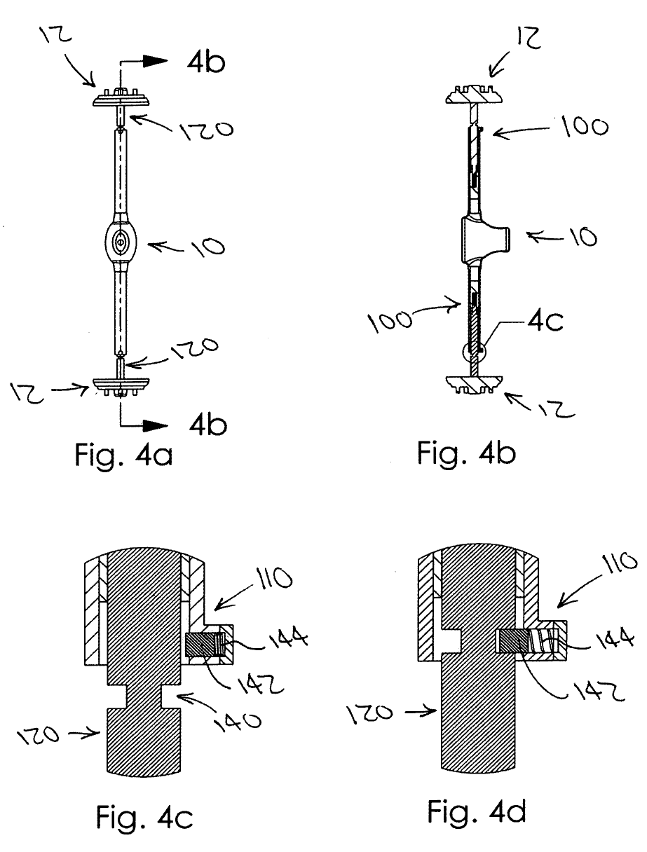

As shown in FIGS. 4c and 4d, either the shaft 120 or the main axle 110 may define a notch 140, and the other (i.e., the shaft 120 or the main axle 110) may include a safety pin 142 that has a configuration complementary to a configuration of the notch 140. The safety pin 142 is biased toward the notch 140, such as by spring 144, and the notch 140 and safety pin 142 are located to interact when the shaft 120 moves toward the main axle 110 a predetermined distance past the equilibrium point. As shown in FIG. 4d, interaction between the safety pin 142 and the notch 140 restricts further movement of the shaft 120 relative to the main axle 110 along the shared axis.

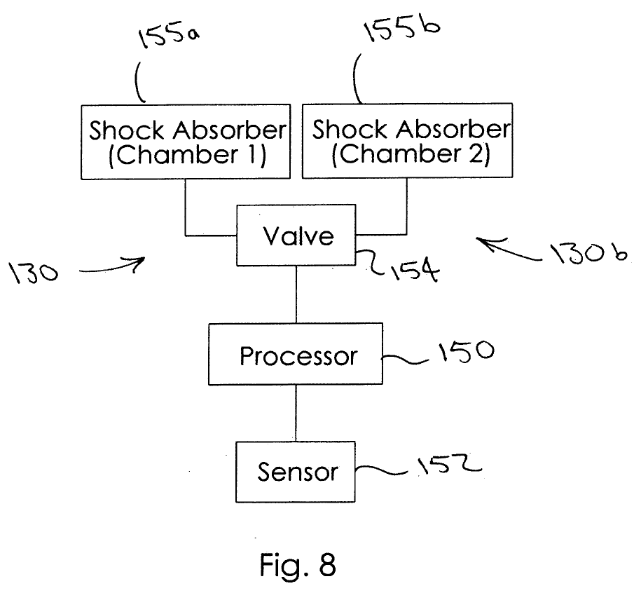

In one embodiment, as shown in FIG. 8, an adjustable force-absorbing member 130 (e.g. an adjustable pneumatic or adjustable hydraulic damper 130b) is used, and a processor 150 is in data communication with the adjustable force-absorbing member 130. An input device 152 (e.g., a sensor or a user-activated input device) is in data communication with the processor 150, and the processor 150 includes programming for adjusting the adjustable force-absorbing member 130 upon receiving data from the input device 152. For example, for an adjustable pneumatic or adjustable hydraulic damper 130b, the processor 150 may include programming for adjusting one or more valve 154 between chambers 155a, 155b, as shown in FIG. 8.

In use, the main axle 110 may be coupled to a vehicle in a traditional manner (e.g., through differential 10 in FIG. 1, etc.), a hub 12 may be coupled to the shaft end 122a, and a tire 14 may be coupled to the hub 12, as shown in FIG. 1. As discussed above, splines 113, 123 may couple the main axle 110 and the shaft 120 and allow the shaft 120 to move along the shared axis relative to the main axle 110. If a resilient force-absorbing member 130 (e.g., spring 130a, etc.) is used, the shaft 120 may be allowed to move along the shared axis during normal use, and the force-absorbing member 130 may return the shaft 120 to the equilibrium point. Movement of the shaft 120 relative to the main axle 110 during use may be desirable, as it may reduce stress on the tires 14 in windy environments and when cornering, in particular.

In case of a side impact (e.g., during an accident), the shaft 120 may move toward the main axle 110, and the force-absorbing member 130 may absorb force from the shaft 120, causing less force to be transferred to the main axle 110. If a resilient force-absorbing member 130 (e.g., spring 130a, etc.) is used, it may be important that safety pin 142 interact with notch 140 to restrict further movement of the shaft 120 relative to the main axle 110, as movement of the shaft 120 back to the equilibrium point (and particularly the forces associated with that movement) could be dangerous.

FIG. 3a shows the spring 130a in normal use (i.e., maintaining the shaft 120 at the equilibrium point), and FIG. 3b shows the spring 130a compressed after the shaft 120 has moved toward the main axle 110. Similarly, FIG. 5b shows the damper 130b in normal use, and FIG. 5a shows the damper 130b after the shaft 120 has moved toward the main axle 110. FIG. 6a shows the permanently-deformable solid 130c in normal use, and FIG. 6b shows the permanently-deformable solid 130c after the shaft 120 has moved toward the main axle 110. The compression of the permanently-deformable solid 130c is permanent, as shown in FIG. 7b, and the permanently-deformable solid 130c may need to be replaced after compression.

If an adjustable force-absorbing member 130 is used, as discussed above, a sensor 152 (e.g., a pressure sensor) and/or a user input 152 may determine how quickly the force-absorbing member 130 may compress, and the processor 150 may adjust the force-absorbing member 130 accordingly. In this manner, the “handling” of the suspension (and specifically the vehicle axle 100) may be further customized.

The invention as described above may be referred to as a “one-way stress absorbing axle” in that it provides for stress absorption when the stress is applied toward the center of the axle. Also contemplated by the present invention, however, is what may be referred to as a “two-way stress absorbing axle” (not shown) in that it provides additional or improved functionality for absorbing stress that may be applied toward the center of the axle as well as stress applied away from the center of the axle. In the two-way stress absorbing axle, not only is there compression of a respective shaft 120 into the main axle 110 upon sensing a stress in the direction of the center of the main axle as with the embodiment 100 described above, the two-way stress absorbing axle allows extension of an opposed shaft relative to an opposed end of the main axle. In this way, the overall length of the vehicle's wheelbase is not shortened by the absorption of a stress and compression of the respective shaft and main axle (as in FIGS. 3c and 3d). It is believed that maintaining a full wheel base, even when experiencing stress such as gravity forces during tight turns, improves driving safety and handling.

It is understood that while certain forms of this invention have been illustrated and described, it is not limited thereto except insofar as such limitations are included in the following claims and allowable functional equivalents thereof.

I claim:

1. A vehicle axle, comprising:
a main axle;
a elongate shaft having opposed ends and being coaxial with said main axle, said shaft being coupled to said main axle and being movable relative to said main axle along said axis; and
a force-absorbing member in communication with said main axle and said shaft to absorb force when said shaft moves toward said main axle past an equilibrium point.

2. The vehicle axle of claim 1, wherein:
one of said shaft and said main axle defines a notch;
another of said shaft and said main axle includes a safety pin having a configuration complementary to a configuration of said notch;
said safety pin is biased toward said notch;
said notch and said safety pin are located to interact when said shaft moves toward said main axle a predetermined distance past said equilibrium point; and
interaction between said safety pin and said notch restricts movement of said shaft relative to said main axle along said axis.

3. The vehicle axle of claim 2, wherein said force-absorbing member is a spring.

4. The vehicle axle of claim 3, wherein:
said shaft includes a plurality of splines;
said main axle includes a plurality of splines complementary to said shaft splines; and
interaction between said shaft splines and said main axle splines couples said shaft to said main axle, causes said shaft and said main axle to rotate in concert, and allows said shaft to move relative to said main axle along said axis.

5. The vehicle axle of claim 4, wherein one said end of said shaft is coupled to said spring and another said end of said shaft is configured to be coupled to a vehicle hub.

6. The vehicle axle of claim 1, wherein said force-absorbing member includes at least one of a spring, a pneumatic damper, a hydraulic damper, and a permanently-deformable solid.

7. The vehicle axle of claim 6, wherein said permanently-deformable solid includes a hollow cylinder having a plurality of holes.

8. The vehicle axle of claim 1, wherein:
said force-absorbing member is an adjustable pneumatic damper;
a processor is in data communication with said adjustable pneumatic damper;
said processor is in data communication with a data input device; and
said processor includes programming for adjusting said adjustable pneumatic damper upon receiving data from said data input device.

9. The vehicle axle of claim 8, wherein:
said shaft includes a plurality of splines;
said main axle includes a plurality of splines complementary to said shaft splines; and
interaction between said shaft splines and said main axle splines couples said shaft to said main axle, causes said shaft and said main axle to rotate in concert, and allows said shaft to move relative to said main axle along said axis.

10. A vehicle axle, comprising:
a main axle having an end with a splined cavity;
a splined shaft coaxial with said main axle, said splined shaft having a configuration that is complementary to a configuration of said splined cavity, said shaft and said main axle being coupled together by said shaft splines and said cavity splines, said shaft being movable relative to said main axle along said axis; and
a force-absorbing member located inside said splined cavity and being in communication with said main axle and said splined shaft to absorb force when said splined shaft moves toward said main axle past an equilibrium point.

11. The vehicle axle of claim 10, wherein:
one of said shaft and said main axle defines a notch;
another of said shaft and said main axle includes a safety pin having a configuration complementary to a configuration of said notch;
said safety pin is biased toward said notch;
said notch and said safety pin are located to interact when said shaft moves toward said main axle a predetermined distance past said equilibrium point; and
interaction between said safety pin and said notch restricts movement of said shaft relative to said main axle along said axis.

12. The vehicle axle of claim 11, wherein said force-absorbing member is a spring.

13. The vehicle axle of claim 10, wherein said force-absorbing member includes at least one of a spring, a pneumatic damper, a hydraulic damper, and a permanently-deformable solid.

14. The vehicle axle of claim 10, wherein:
said force-absorbing member is an adjustable pneumatic damper;
a processor is in data communication with said adjustable pneumatic damper;
said processor is in data communication with a data input device; and
said processor includes programming for adjusting said adjustable pneumatic damper upon receiving data from said data input device.

15. A vehicle axle, comprising:
a main axle having a splined end;
a shaft having a splined end, said shaft being coaxial with said main axle, said splined end of said shaft being coupled to said splined end of said main axle, said shaft being movable relative to said main axle along said axis; and
a force-absorbing member in communication with said main axle and said shaft to absorb force when said shaft moves toward said main axle past an equilibrium point.

16. The vehicle axle of claim 15, wherein:
one of said shaft and said main axle defines a notch;
another of said shaft and said main axle includes a safety pin having a configuration complementary to a configuration of said notch;
said safety pin is biased toward said notch;
said notch and said safety pin are located to interact when said shaft moves toward said main axle a predetermined distance past said equilibrium point; and
interaction between said safety pin and said notch restricts movement of said shaft relative to said main axle along said axis.

17. The vehicle axle of claim 16, wherein said force-absorbing member is a spring.

18. The vehicle axle of claim 17, wherein said spring is coupled to one end of said shaft and said main axle to bias said shaft toward said equilibrium point when said shaft has moved away from said main axle past said equilibrium point.

19. The vehicle axle of claim 15, wherein said force-absorbing member includes at least one of a spring, a pneumatic damper, a hydraulic damper, and a permanently-deformable solid.

20. The vehicle axle of claim 15, wherein:
said force-absorbing member is an adjustable pneumatic damper;
a processor is in data communication with said adjustable pneumatic damper;
said processor is in data communication with a data input device; and
said processor includes programming for adjusting said adjustable pneumatic damper upon receiving data from said data input device.
